(19) United States
(12) Patent Application Publication
(10) Pub. No.: US 2003/0002863 A1
(43) Pub. Date: Jan. 2, 2003

(54) System and method for presenting updated DVD information screen

(75) Inventor: Hiroaki Shinohara, San Diego, CA (US)

Correspondence Address: John L. Rogitz, Rogitz & Associates, Suite 3120, 750 B Street, San Diego, CA, 92101, US

(73) Assignee: SONY CORPORATION, Tokyo (JP)

(21) Appl. No.: 09/897,310

(22) Filed: Jul. 2, 2001

(51) Int. Cl. H04N 5/781

(52) U.S. Cl. 386/125; 386/126

(57) ABSTRACT

A system and method for presenting updated movie/DVD content in the information screen that is presented during play of a DVD. The information screen can be updated periodically over the Internet and stored on a local hard disk drive (HDD), such that an older DVD can be played and an updated information screen displayed with content that might list, e.g., new movies that star the actor in the DVD movie, or otherwise might be related or of interest to a person who just watched the DVD movie.

### BACKGROUND OF THE INVENTION

1. Field of the Invention

The present invention relates generally to television systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a computer system characteristic, and less toward entertainment (“lean back”), generally regarded as a television system characteristic. It is not just the dichotomy between productivity and entertainment that distinguishes a “lean forward” experience from a “lean back” experience, however. As contemplated herein, “lean back” activities can extend to purchasing products that are advertised on TV, as opposed to, e.g., making products for sale. In any case, with the above-mentioned critical observation of the present invention in mind, it can readily be appreciated that the differences between a system designed for “lean forward” experiences and a system designed for “lean back” experiences can be both subtle and profound.

In the above context, the present invention recognizes that in one aspect of a lean-back experience, a viewer might be interested in obtaining further programming that is related to something the viewer found interesting in, for instance, a digital video disk (DVD) program that the viewer displays on the TV. For example, a viewer might be interested in viewing additional movies that star an actor featured on a DVD movie. Conventionally, a DVD player might present, as a prelude to a DVD movie, information on what other studio movies are available, or on what other movies an actor in the current movie appears. The present invention critically observes that as a DVD ages, it might still be played for entertainment but the prelude information might grow outdated, failing to include the latest studio or actor films. The viewer would thus be deprived of knowing about the latest related movies in which the viewer might have an interest. The present invention understands that it would be advantageous to provide a viewer with a means to obtain up-to-date recommended programming/products.

### SUMMARY OF THE INVENTION

A system for presenting up-to-date information related to a media-stored content includes a TV and a digital video disk (DVD) player coupled to the TV. The DVD includes a processor that determines whether updated information relating to a disk being played on the DVD player is stored in a memory such as but not limited to a hard disk drive or flash memory. If so, the processor displays the updated information in an information screen. Otherwise, the processor displays an information screen contained on the disk.

Preferably an input device can be manipulated to cause the screen to be displayed. The updated information can be received, if desired, from a wide area computer network (WAN) or from a DVD. In any case, the updated information can include DVD releases and theater movie releases. The updated information can be received, if desired, only after a viewer signal is generated indicating a desire to download updated information.

In another aspect, a method for updating an information screen stored on a DVD includes receiving, in a hard disk drive (HDD), updated information pertaining to the DVD. The method also includes displaying the updated information in an information screen as the DVD is being played.

In still another aspect, a system includes a TV, a disk player coupled to the TV for playing at least one disk having content thereon, and a processor. The processor causes an information screen to be displayed on the TV at least in part based on the disk. The screen includes content recommendations for a viewer, at least some of which are received from a storage other than the disk.

In yet another aspect, a system for presenting up-to-date information related to a media-stored content includes a TV and a digital video disk (DVD) player coupled to the TV. The DVD player includes a processor that determines whether updated information relating to a disk being played on the DVD player is stored in a storage other than the disk, and if so, displaying the updated information in lieu of corresponding original information on the disk, and otherwise displaying the corresponding original information on the disk. In this way, updated information for a DVD information screen or indeed any part of the content on the DVD, such as a portion of a movie, can be played in lieu of the original corresponding content on the DVD.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention;

FIG. 2 is a flow chart of the present logic; and

FIG. 3 is a schematic view of a disk-stored information screen and how it can be updated using more current information from storage.

### DETAILED DESCRIPTION OF THE PREFERRED EMBODIMENTS

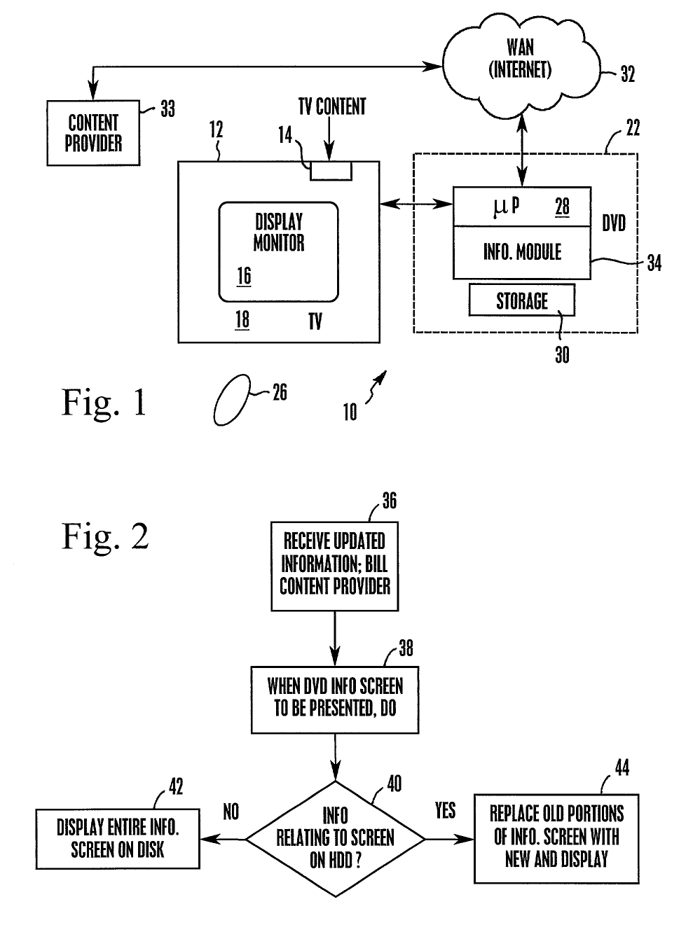

Referring initially to FIG. 1, a system is shown, generally designated 10. As shown, the system 10 includes a TV 12 that conventionally receives televised content at a content receiver 14 (e.g., an antenna, satellite dish, set-top box, etc.) for display of the content on a monitor 16.

While the embodiment below discusses a TV 12 with a single housing that is shown separate from the microprocessor and database, it is to be understood that the term “television” encompasses any apparatus that has a television tuner and the below-described capability in a single housing or in separate housings that cooperate together. For instance, the term “TV” encompasses the television system shown in FIG. 1, as well as a conventional television in combination with an auxiliary component such as a set-top box, DVD player, personal video recorder (PVR), etc. that functions in accordance with the present invention. In the latter example, the auxiliary component might include, e.g., the microprocessor discussed below. In a less preferred embodiment, the microprocessor discussed below can be a standalone computer such as a PC or laptop with its own monitor (not shown), and can communicate with the TV 12 by wired or wireless link or simply by transferring data from the TV to the computer using, e.g., a floppy diskette.

In the preferred non-limiting embodiment shown, the TV 12 includes a housing 18 that holds a conventional television tuner which receives the TV signals. The audio and video settings of the TV, i.e., the volume, tone, tint, color, contrast, and so on as conventionally provided in the art, are established by respective adjustable audio and video setting circuits. Also, the TV 12 can display media-stored content, including disk-stored content 20, on the monitor 16 that is received from a peripheral recording device associated with the TV, such as but not limited to a DVD player 22 that can play DVDs 23 in accordance with principles known in the art. While for convenience a DVD player 22 is assumed, it is to be understood that the present invention also encompasses the use of players other than the DVD player 22, e.g., a CD player or a VCR.

While FIG. 1 shows that the DVD player 22 is separate from the TV housing 18, it is to be understood that the player 22 can be incorporated into the housing 18. In any case, the media-stored content provided from the peripheral device, that is, the player that is associated with the TV, is distinct from broadcast content received from an antenna, satellite dish, or cable. When used without a modifier, however, “content” refers to both media-stored content and to broadcast content.

The content 20 is automatically or selectively displayed by a viewer by appropriately manipulating a remote control user input device 26 or other controls located on the housing 18. It is to be understood that while FIG. 1 shows that the U/I device 26 can be a conventional TV remote control device, other devices can be used, such as but not limited to keyboards, keypads, mice, touch screen technology, voice activation/recognition technology, etc.

A microprocessor 28 can store updated content in a database 30, preferably on a hard disk drive (HDD). As intimated above, the preferred microprocessor 28 is integrated with the TV 12, either in the housing 18 or more preferably in a separate but associated housing such as the DVD player 22 in such a manner as to receive the content automatically.

If desired, the microprocessor 28 can also communicate with a wide area network (WAN) such as but not limited to the Internet 32 via cable or wire modem, DSL link, wireless link, or other network link in accordance with principles known in the art to access computer sites on, e.g., the World Wide Web. For instance, a content provider server or site 33 can be accessed via the WAN 32.

The microprocessor 28 accesses a software-implemented information screen module 34 to execute the logic set forth herein. The database 30 can be contained in computer memory, or on a hard disk drive, optical drive, solid state storage, tape drive, removable flash memory, or any other suitable data storage medium in the DVD 22 or in an associated component such as but not limited to a personal video recorder (PVR).

It may now be appreciated that the microprocessor 28 undertakes the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

Now referring to the logic diagram shown in FIG. 2, at block 36 updated information regarding the latest movie releases, DVD releases, etc. is downloaded over the WAN 32 from, e.g., the content provider server or site 33 to the storage 30. By “updated” may mean that an existing information screen in the storage 30 is updated with new information, or an entirely new version of an older screen is received into the storage, and the older screen flushed from memory. The download can be automatic or it can be done pursuant to a viewer responding “yes” to the query, “Do you want the latest information regarding this DVD?” In the latter case, the viewer can be awarded electronic coupons or other incentives to download the latest information. It is to be understood that an information screen can be a single screen or a series of nested screens, as set forth further below.

As an alternative, the updated information can be downloaded from a DVD. In this case, each new DVD would contain, relative to its manufacture date, the latest movie/DVD information. When an older DVD is played subsequent to playing the newer disk, the information from the newer disk can be available in the storage 30. Regardless of how received, the content provider or other entity can be billed for the download.

Next moving to block 38, when a DVD-stored information screen is to be displayed, either automatically or in response to a viewer pressing a button on the remote control U/I device 26 a DO loop is entered to present an information screen on the monitor 16. Proceeding to decision diamond 40, it is determined, for the particular DVD being played, whether related information has been saved to the storage 30, e.g., to a hard disk drive of the DVD player 22. In making the determination at decision diamond 40, the identification of the disk being played in the DVD player 22 can be compared to the identifications of information saved in the storage 30.

When updated information has not been received in the storage 30, the logic moves to block 42 to display the entire information screen as it had been stored on the disk 23 during content recording. On the other hand, when updated information is present in the storage 30, the logic moves to block 44 to replace any outdated portions of information on the disk 23 with newer information from the storage 30, or simply to add the newer information in the storage 30 to the screen. The screen is then displayed, showing the latest information of interest related to the content on the disk 23.

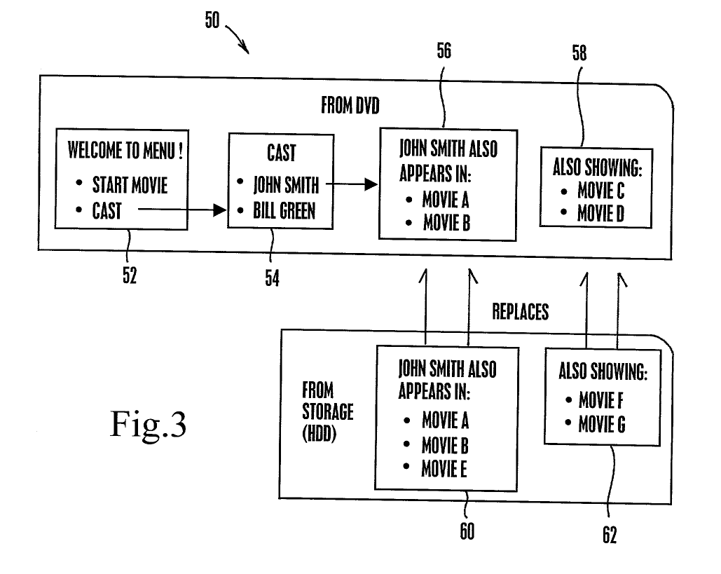

FIG. 3 illustrates the above logic. As shown, an information screen 50 from the DVD 23 includes a set of individual screens. More specifically, a menu screen 52 can be presented that lists, among other things, the cast of the movie on the DVD 23. A viewer can select “cast” to display a cast screen 54 that lists the actors appearing in the movie. A viewer can further select “John Smith” to display, if no updated information pertaining to the disk 23 exists in the storage 30, a related movie screen 56, listing other movies in which the selected actor appears. In the illustration shown, when the disk 23 was released the actor had appeared in two other movies, movie “A” and movie “B”, and so the related movie screen 56 on the disk 23 lists just those two movies.

Likewise, an auxiliary related movie screen can list other movies from the same studio that produced the DVD movie that were appearing in local theaters when the DVD 23 was released. In the illustration shown, movies “C” and “D” were playing in theaters.

However, when updated information screens pertaining to one of the screens 56, 58 is downloaded to storage 30, the corresponding updated information screens 60, 62 are displayed in place of the disk-stored screens 56, 58. Thus, for instance, an updated related movie screen 60 that lists not only movies “A” and “B” as being movies in which “John Smith” appears, but movie “E” as well, will be retrieved from the storage 30 and displayed in lieu of the screen 56 when the viewer selects “John Smith” from the cast screen 54. Likewise, an updated auxiliary related movie screen 62 that lists movies “F” and “G” as being currently shown in theaters will be retrieved from the storage 30 and displayed in lieu of the screen 58.

While the above disclosure focusses on updating an information screen of a DVD, the principles of the present invention can apply more broadly, to updating any portion of DVD-stored content. For instance, a new ending for an older DVD movie might be downloaded into the storage 30 and shown in lieu of the original ending stored on DVD the next time the DVD is played.

While the particular SYSTEM AND METHOD FOR PRESENTING UPDATED DVD INFORMATION SCREEN as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

What is claimed is:

1. A system for presenting up-to-date information related to a media-stored content, comprising:
a TV; and
a digital video disk (DVD) player coupled to the TV and including a processor, the processor determining whether updated information relating to a disk being played on the DVD player is stored in a memory, and if so, displaying the updated information in an information screen, and otherwise displaying an information screen contained on the disk.

2. The system of claim 1, further comprising an input device manipulable to cause the screen to be displayed.

3. The system of claim 1, wherein the updated information is received from a wide area computer network (WAN).

4. The system of claim 1, wherein the updated information is received from a DVD.

5. The system of claim 1, wherein the updated information includes DVD releases and theater movie releases.

6. The system of claim 1, wherein the updated information is received only after a viewer signal is generated indicating a desire to download updated information.

7. A method for updating an information screen stored on a DVD, comprising:
receiving, in a memory, updated information pertaining to the DVD; and
displaying the updated information in an information screen as the DVD is being played.

8. The method of claim 7, comprising receiving the updated information from a WAN.

9. The method of claim 7, comprising receiving the updated information from a disk.

10. The method of claim 7, further comprising receiving the updated information only in response to a signal from an input device.

11. The method of claim 7, further comprising incentivizing a viewer to access the updated information.

12. A system, comprising:
a TV;
a disk player coupled to the TV for playing at least one disk having content thereon; and
a processor causing at least one information screen to be displayed on the TV at least in part based on the disk, the screen including content received from a storage other than the disk.

13. The system of claim 12, wherein the disk is a DVD and the player is a DVD player.

14. The system of claim 13, wherein the processor is held within a housing of the DVD player.

15. The system of claim 13, wherein the storage is at least one hard disk drive (HDD).

16. The system of claim 15, wherein the information includes at least one of: at least one DVD release, and at least one theater movie release.

17. The system of claim 15, further comprising a remote control user input device manipulable to control the TV and/or DVD player.

18. The system of claim 12, wherein the updated information is received from a wide area computer network (WAN).

19. A system for presenting up-to-date information related to a media-stored content, comprising:
a TV; and
a digital video disk (DVD) player coupled to the TV and including a processor, the processor determining whether updated information relating to a disk being played on the DVD player is stored in a storage other than the disk, and if so, displaying the updated information in lieu of corresponding original information on the disk, and otherwise displaying the corresponding original information on the disk.

20. The system of claim 19, further comprising an input device manipulable to cause the information to be displayed.

21. The system of claim 19, wherein the updated information is received from a wide area computer network (WAN).

22. The system of claim 19, wherein the updated information is received from a DVD.

23. The system of claim 19, wherein the updated information is received only after a viewer signal is generated indicating a desire to download updated information.
